(19) United States
(12) Patent Application Publication
(10) Pub. No.: US 2005/0028080 A1
(43) Pub. Date: Feb. 3, 2005

(54) Method and system for publishing dynamic Web documents

(76) Inventors: James R.H. Challenger, Garrison, NY (US); Cameron Ferstat, Sleepy Hollow, NY (US); Arun K. Iyengar, Yorktown Heights, NY (US); Paul Reed, Harrison, NY (US); Gerald A. Spivak, Mohegan Lake, NY (US); Karen A Witting, Ossining, NY (US)

Correspondence Address: F. CHAU & ASSOCIATES, LLC, 130 WOODBURY ROAD, WOODBURY, NY, 11797, US

(21) Appl. No.: 10/924,286

(22) Filed: Aug. 23, 2004

Related U.S. Application Data
(63) Continuation of application No. 09/283,542, filed on Apr. 1, 1999, now abandoned.

(51) Int. Cl. G06F 17/00

(52) U.S. Cl. 715/501.1

(57) ABSTRACT

A method for constructing a plurality of objects, in accordance with the present invention includes the steps of providing a plurality of fragments, providing at least one fragment, determining an order for constructing objects based on at least one inclusion relationship between an object and the at least one fragment and constructing the plurality of objects based on the at least one inclusion relationship and the determined order for constructing the objects. A program storage device is also described. A system for constructing a plurality of objects, in accordance with the present invention, includes a content authoring system for generating fragments and providing include relationships between the fragments. A dependency parser is included for receiving the fragments and parsing the include relationships. A dependency analyzer is provided for determining an efficient order for constructing the plurality of objects from the fragments based on the include relationships. A constructor constructs the plurality of objects in the order determined by the dependency analyzer.

### BACKGROUND OF THE INVENTION

1. Field of the Invention

The present invention relates to computerized publication of documents, and more particularly to a method for publishing documents on the World Wide Web.

2. Description of the Related Art

Web sites often present content which is constantly changing. Presenting current information to the outside world without requiring an inordinate amount of human effort and computing power is a major technical challenge to Web site designers.

Therefore, a need exists for a system and method for generating documents which result in more flexibility providing the capability for constant change to the documents. A further need exists for a method for permitting documents to include multiple fragments wherein the fragments are dynamically updated in an optimal order to accommodate changes.

### SUMMARY OF THE INVENTION

A method for constructing a plurality of objects, in accordance with the present invention includes the steps of providing a plurality of fragments, providing at least one fragment, determining an order for constructing objects based on at least one inclusion relationship between an object and the at least one fragment and constructing the plurality of objects based on the at least one inclusion relationship and the determined order for constructing the objects.

A program storage device readable by machine, tangibly embodying a program of instructions executable by the machine to perform method steps for constructing a plurality of objects, the method steps include providing at least one fragment, determining an order for constructing objects based on at least one inclusion relationship between an object and the at least one fragment and constructing the plurality of objects based on the at least one inclusion relationship and the determined order for constructing the objects.

In alternate methods which may be implemented through a program storage device, the step of determining at least one inclusion relationship between the at least one fragment and the object may be included. The step of verifying one of an existence and a currency of a first object referenced by a second object may also be included. The step of delaying publication of the second object in response to the first object being one of non-existent and obsolete may be included. The steps of examining a plurality of constructed objects, rejecting at least one constructed object based on content and approving remaining constructed objects for publication may further be included. The objects preferably include Web pages and may further include the step of detecting broken hypertext links between Web pages. The steps of detecting changes to the objects and automatically updating the objects according to the order may also be included.

A system for constructing a plurality of objects, in accordance with the present invention, includes a content authoring system for generating fragments and providing include relationships between the fragments. A dependency parser is included for receiving the fragments and parsing the include relationships. A dependency analyzer is provided for determining an efficient order for constructing the plurality of objects from the fragments based on the include relationships. A constructor constructs the plurality of objects in the order determined by the dependency analyzer.

In alternate embodiments, the dependency analyzer preferably employs object dependence graphs to determine an order for constructing the objects. The content authoring system may include fragments input from humans, machines and combinations of humans and machines. The system may further include a consistency checker for delaying publication of inconsistent objects. The system preferably constructs Web pages and the consistency checker may further includes a component for determining broken hypertext links between the Web pages. The constructor may include a page constructor for constructing Web pages from the plurality of objects.

Another method for constructing a plurality of objects, which may be implemented by employing a program storage device includes the steps of providing a plurality of fragments, determining an order for constructing objects based on at least one inclusion relationship between the plurality of fragments, and constructing the plurality of objects based on the at least one inclusion relationship and the determined order for constructing the objects.

These and other objects, features and advantages of the present invention will become apparent from the following detailed description of illustrative embodiments thereof, which is to be read in connection with the accompanying drawings.

### BRIEF DESCRIPTION OF DRAWINGS

The invention will be described in detail in the following description of preferred embodiments with reference to the following figures wherein:

FIG. 1 is a block diagram for a system for constructing and publishing one or more servables in accordance with the present invention;

FIG. 2 is a block/flow diagram of a system/method for creating and publishing one or more servables in accordance with the present invention;

FIG. 3 is a block/flow diagram of a system/method for constructing one or more servables;

FIG. 4 is a flow diagram of another method for constructing and publishing one or more servables.

### DETAILED DESCRIPTION OF PREFERRED EMBODIMENTS

The present invention provides a system and method for publishing documents, for example Web documents, which are constantly changing, i.e., dynamic. In a preferred embodiment of the present invention, compound Web pages are composed from fragments. A fragment is an object which is used to construct a compound object. An object is an entity which can either be published or is used to create something which is publishable. Objects include both fragments and compound objects. A compound object is an object constructed from one or more fragments. In response to a change in one or more fragments, the present invention detects which documents, such as, Web pages, are affected by the change as well as an optimal order for constructing updated documents (pages).

Generating updated documents in response to changes is automated by a system which preferably includes software modules. Users are provided with an easy-to-use mechanism for specifying inclusion relationships among Web pages and fragments. The system then detects when updates need to take place and automatically updates and publishes pages in a computationally efficient manner. Generating pages may take place in several phases. For example, an initial content author may generate an initial set of pages. Subsequently, a second author may fill in additional information and make modifications to the content provided by the first author. Then, a proofreader/censor can verify that the contents are correct and proper before the pages or objects are published. Publishing an object means making it visible to a specific group of people (e.g. the public). Publishing is decoupled from creating or updating an object and generally takes place after the object has been created or updated.

The present invention further includes the capability to detect broken hypertext links and can delay publication of a page or object until all pages (or objects) referenced by the page which was delayed for publication are also published.

In accordance with the present invention, the authors specify inclusion relationships via a markup language. For example, a Web page p1 may include a fragment f1 which may in turn include another fragment f2. Suppose f2 is included in multiple Web pages. The present invention will only generate f2 one time regardless of how many times f2 is included in other pages thereby providing an efficient system. In addition, graph traversal algorithms ensure that f2 will be generated before all compound objects which include f2.

After the authors have specified inclusion relationships via the markup language for all pages the authors wish to publish, the pages are parsed to determine the inclusion relationships. This results in an object dependence graph (ODG). An object dependence graph (ODG) is a directed graph in which nodes/vertices correspond to objects. ODG's may have one or more types of edges. For example, a dependence edge from a node corresponding to an object “a” terminating in a node corresponding to an object “b” indicates that a change to “a” also affects “b”. ODG's are also described in a commonly assigned disclosure, U.S. Ser. No. 08/905,114 incorporated herein by reference. The ODG is used for a number of things including but not limited to determining all of the objects affected by changes to underlying data and determining an optimal ordering for constructing objects after changes. Graph traversal algorithms are applied to the ODG to determine an optimal order for constructing compound objects from fragments.

If the authors are not satisfied with the results, the authors may make modifications to the pages and repeat this process until satisfied. Once the authors are satisfied, a set of objects may be passed on to a next group of authors who may modify content or add new content. After all the authors have finished with the Web pages, a censor or proofreader may make a final determination of which pages to publish and which pages to hold back. A quick publishing and censoring system and method which may be used is described in “METHOD AND SYSTEM FOR RAPID PUBLISHING AND CENSORING INFORMATION”, Attorney docket number YO999-040(8728-253), filed concurrently herewith, commonly assigned and incorporated herein by reference.

The present invention further includes a component which recognizes hypertext links in a page via parsing. The component verifies that the hyperlinks are not broken. In the event that a broken hyperlink is detected, there are several options which may be set by users. These may include the following:

(1) ignore the broken hypertext link;

(2) reject the page for publication and notify an author of the reason for rejection;

(3) automatically delete the broken hypertext link;

(4) delay publishing the page but retry periodically to see if the hypertext links are fixed; and

(5) if the hypertext link is to an unpublished object on a local Web site, try to publish the referenced object. This may include recursively making sure that there are no broken hypertext links on the referenced object.

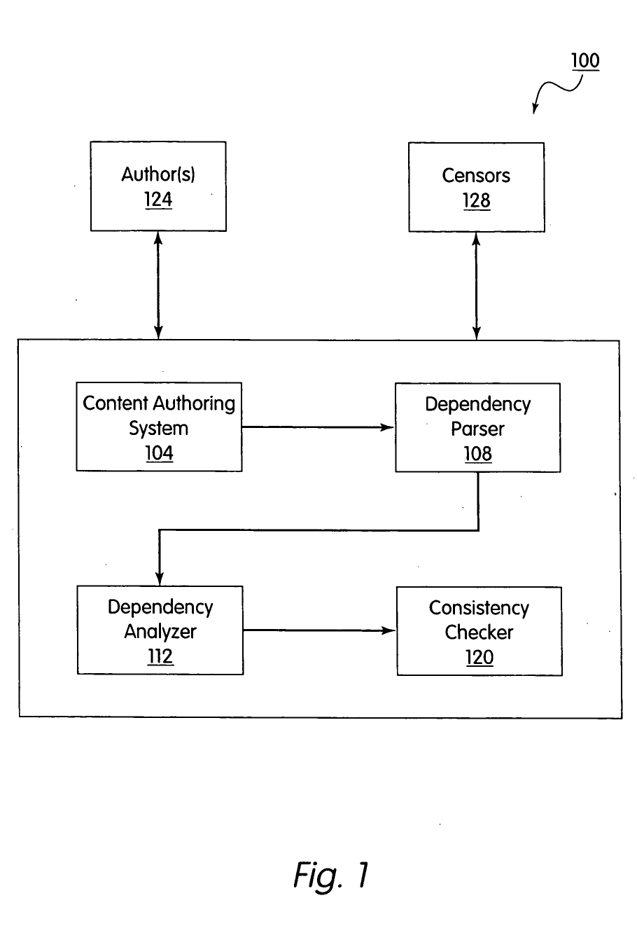

It should be understood that the elements shown in FIGS. 1-4 may be implemented in various forms of hardware, software or combinations thereof unless otherwise specified. Preferably, these elements are implemented in software on one or more appropriately programmed general purpose digital computers having a processor and memory and input/output interfaces. Referring now to the drawings in which like numerals represent the same or similar elements and initially to FIG. 1, a block diagram of a system 100 in accordance with the present invention is shown for creating and publishing one or more servables. A servable is a complete entity which may be published. For example, a Web page could be a servable at a Web site. A bundle is a set of servables. In the present invention, servables belonging to the same bundle are often published together.

In many cases, the publishing process is a continuous one which iterates several times. After initialization, a set of one or more servables may be visible to outside viewers. If this is the case, authors use the system depicted in FIG. 1 to modify objects which results in changes to the servables visible to the outside viewers. Authors 124 may include but are not limited to humans, machines, or some combination of humans and machines. Similarly, censors 128 may include but are not limited to humans, machines, or some combination of humans and machines. Censors 128 and authors 124 interact with the system as will be described herein.

A content authoring system 104 is included for authoring fragments, etc. for use with the present invention. Content authoring system 104 is preferably interactive with authors 124. A dependency parser 108 is included which examines objects for include directives and updates ODG's based on the include directives the dependency parser 108 identifies. A dependency analyzer 112 is also included which is invoked to determine a correct and efficient order for constructing multiple objects. A page constructor 116 is included which is invoked to construct updated versions of one or more objects from dependency analyzer 112. When a compound object is constructed, include directives referencing fragments are replaced by the actual fragments. If several objects are being constructed, the objects are constructed in the order determined by dependency analyzer 112. A consistency checker 120 may be included in system 100 which may notify the author(s) 124 of one or more dangling references the consistency checker 120 detects within a servable. Appropriate actions may then be taken as will be described below.

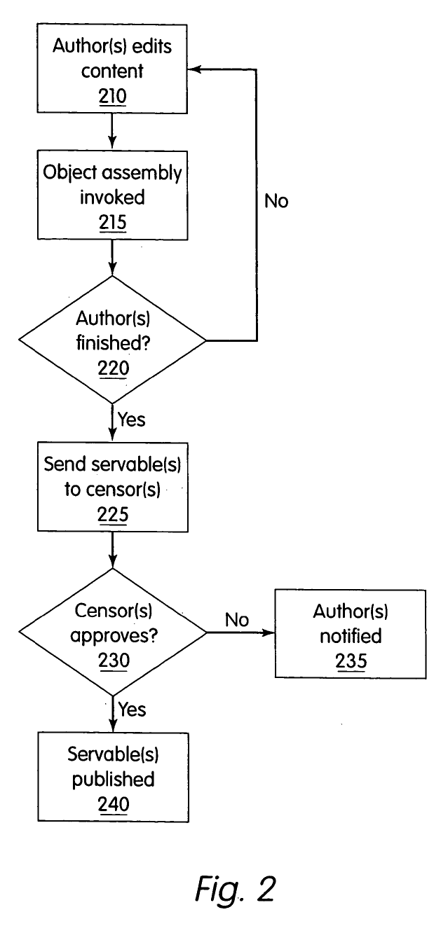

Referring to FIG. 2, a block/flow diagram is shown for creating and publishing one or more servables. In block 210, at least one author 124 creates, deletes, and/or modifies one or more objects. Some of the objects may be compound objects which include fragments. Objects are specified in a markup language such as HTML, XML, etc. The representation of an object in a markup language is known as a template. A template is a representation of an object in a markup language such as HTML, XML, etc. The present invention permits authors 124 to specify inclusion relationships using special directives within a template. For example, suppose a compound object col is to include a fragment f1 (not shown). This may be specified by a directive of the following form in the template for co: <!--#incl “f1” -->

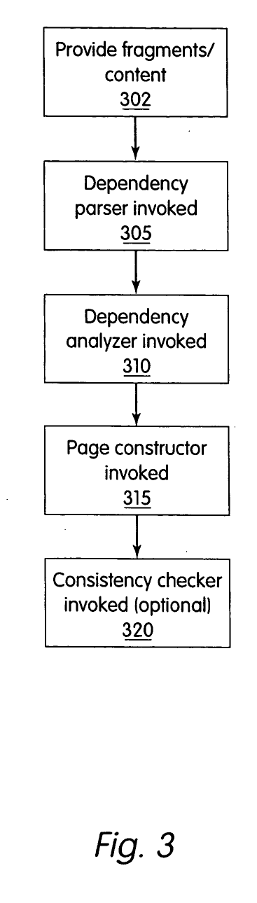

In block 215, current versions of servables are constructed whose values may be affected by the editing changes in block 210. A preferred method of implementing block 215 is depicted in FIG. 3. Other methods may be used as well in accordance with the invention. In block 220, the author(s) 124 views one or more servables produced in block 215. If the author(s) 124 would like to make additional changes before publication, processing returns to block 210. If, on the other hand, the author 124 is satisfied with the servables, the author 124 selects a set of servables to be published in block 225 which are then sent to a censor(s) 128. This set of servables is known as a bundle as described above.

There are several methods by which the author(s) may select the servables to be published in block 225. These methods may preferably include selecting all servables which the system identifies in block 215 as having changed. This may be a default method which results in consistent publication. Different methods may also be used to select specific servables as well.

In block 230, one or more censors 128 examine the bundle to determine if it can be published in accordance with predetermined criteria or rules. The censor(s) 128 also attempts to catch mistakes and prevent objectionable material from being published. If the censor(s) 128 approves of the bundle, all servables in the bundle are published together in block 240. If the censor(s) 128 finds any servables which should not be published, the entire bundle is rejected and the author(s) 124 is notified in block 235. The author(s) 124 may then modify content as needed to fix the problems. If this course of action is followed, processing returns to block 210. The censor 128 will usually not reject some servables in a bundle but publish the remainder because this could result in the publication of inconsistent information.

The present invention has the ability to perform several of the functions in FIG. 2, concurrently. For example, different authors may be concurrently creating content. In addition, it is possible for several bundles to be awaiting approval by the censor(s) 128 in block 230. If two bundles are both awaiting approval by the censor(s) 128, it is possible to combine the two bundles into a single larger bundle; If the two bundles have different versions of the same servable, the combined bundle will include the later version of the servable in accordance with the invention.

Referring to FIG. 3, a block/flow diagram of a system/method for constructing one or more servables is shown. The servables may include compound objects. The servables are preferably represented by templates in a markup language which specifies included fragments using directives of the form described earlier. One key function performed in FIG. 3 is construction of a representation of compound objects which includes directives in templates which are replaced by the actual fragments the directives represent. In block 302, a plurality of information fragments (or objects) are provided. In block 305, a dependency parser is invoked on one or more objects. The dependency parser determines inclusion relationships among objects by searching for include directives in their representations. A dependency analysis is performed in block 310. There are several methods for implementing both blocks 305 and 310. In a preferred method, include relationships are represented between objects using ODG's as described in “METHOD AND SYSTEM FOR EFFICIENTLY CONSTRUCTING AND CONSISTENTLY PUBLISHING WEB DOCUMENTS”, Attorney docket number YO999-011(8728-255), filed concurrently herewith, commonly assigned and incorporated herein by reference. Using this preferred method, a dependency parser 108 (FIG. 1) examines objects for include directives in block 305 and updates ODG's based on the include directives dependency parser 108 identifies. In block 310, a dependency analyzer 112 (FIG. 1)is invoked to determine a correct and efficient order for constructing multiple objects. There are several methods for implementing block 310. A preferred method is described in “METHOD AND SYSTEM FOR EFFICIENTLY CONSTRUCTING AND CONSISTENTLY PUBLISHING WEB DOCUMENTS”, previously incorporated herein by reference. This preferred method insures that fragments will be constructed before compound objects which include the fragments.

There may be relationships between objects in addition to relationships defined by inclusion. These relationships may also be captured by the present invention as well. One method for representing such auxiliary relationships is by using multiple edge types in ODG's. Different edge types may be used to represent different types of relationships. Graph traversal algorithms may be applied to the different edge types to determine changed objects based on the different relationships.

In block 315, a page constructor 116 (FIG. 1) is invoked to construct updated versions of one or more objects. When a compound object is constructed, include directives referencing fragments are replaced by the actual fragments. If several objects are being constructed, the objects are constructed in an order (possibly a partial order) determined in block 310. Block 320 may optionally be included in which a consistency checker 120 (FIG. 1) is invoked. Suppose that a servable sl references another servable s2 which is not in the bundle. The consistency checker 120 includes a component for detecting broken hyperlinks which is used, for example, to prevent s1 from being published before s2 is published (i.e. a dangling reference). If s1 and s2 are Web pages, this means preventing s1 from being published with a broken hypertext link to s2. The consistency checker 120 notifies the author(s) 124 of any dangling references the consistency checker 120 detects within a servable. The author can take appropriate action such as fixing dangling references before publishing, removing servables with dangling references from a bundle, or in some cases allowing servables with dangling references to be published. The consistency checker 120 can be configured to fix dangling references in block 320. The following techniques may be employed by the consistency checker 120:
(1) Delete dangling hypertext links.
(2) If a dangling reference is to an object “o” which the consistency checker 120 has the power to generate, try to generate the referenced object. The consistency checker 124 can be configured to recursively invoke itself on “o”. The consistency checker 120 may also be invoked at an earlier stage. For example, it is possible to invoke the consistency checker 120 before the page constructor 116 is invoked in block 315.

There are a number of variations of the present invention. For example, it is not necessary to specify all instances of a compound object “o” including a fragment “f” by include directives in the preconstructed representation of “o”. Instead, an edge in the ODG from “f” to “o” may be sufficient to define this relationship. Using this approach, authors 124 may specify changes to inclusion relationships by application program interface(API) function calls which modify ODG's appropriately. Alternatively, the authors may specify changes to inclusion relationships via text strings (e.g. stored in a file) which may specify the changes to ODG's. A parser may interpret these text strings. Authors 124 may modify ODG's using other methods as well. The present invention may be employed for non-Web documents as well as Web documents.

It is also possible to have several stages similar to block 230. For example, there may be multiple censors 128; each censor 128 may approve and/or reject content in a different stage.

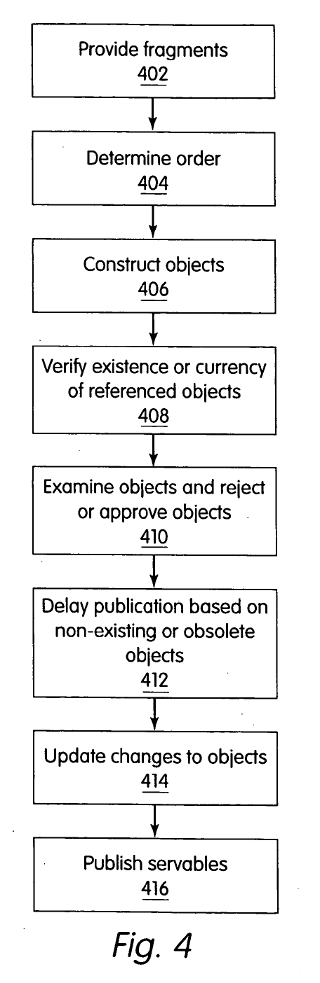

Referring to FIG. 4, another method for constructing and publishing objects is shown. In step 402, a plurality of information fragments are provided. In step 404, an order for constructing objects based on at least one inclusion relationship between at least two information fragments is determined. Inclusion relationships among the plurality of information fragments may be specified by authors or by other means. In step 406, the plurality of objects are constructed based on the at least one inclusion relationship and the determined order for constructing the objects. In step 408, verification of an existence and/or a currency of objects which reference other objects is preferably included. In step 410, the steps of examining a plurality of constructed objects, rejecting constructed objects based on content and approving remaining constructed objects for publication is included. In step 412, a step of delaying publication of objects in response to other references objects being non-existent or obsolete may be included. Delay in publication may also be provided for objects which need correction. The objects preferably include Web pages and may further include the step of detecting broken hypertext links between Web pages. In step 414, detecting changes to the objects according to updates and automatically updating the objects according to the order is preferably performed. The objects or servables are published in step 416. If correction or fixing is needed the method path is returned to previous steps as appropriate.

Having described preferred embodiments of a system and method for publishing dynamic web documents (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A computer-executable method for constructing objects comprising the steps of:
providing at least one fragment, wherein a fragment is an object that is a component of an object which is constructed using the fragment;
determining an order for constructing a plurality of publishable objects based on at least one inclusion relationship between an object and the at least one fragment; and
constructing the plurality of publishable objects based on the at least one inclusion relationship and the determined order for constructing the objects.

2. The method as recited in claim 1, further comprising the step of determining the at least one inclusion relationship between the at least one fragment and the object.

3. The method as recited in claim 1, further comprising the step of verifying one of an existence and a currency of a first object referenced by a second object.

4. The method as recited in claim 3, further comprising the step of delaying publication of the second object in response to the first object being one of non-existent and obsolete.

5. The method as recited in claim 1, further comprising the steps of:
rejecting at least one constructed object based on content; and
approving publication of at least one of remaining constructed objects.

6. The method as recited in claim 1, wherein the objects include Web pages and further comprising the step of detecting broken hypertext links between Web pages.

7. The method as recited in claim 1, further comprising the steps of:
detecting changes to the objects; and
automatically updating the objects according to the order.

8. A program storage device readable by machine, tangibly embodying a program of instructions executable by the machine to perform method steps for constructing objects, the method steps comprising:
providing at least one fragment, wherein a fragment is an object that is a component of an object which is constructed using the fragment;
determining an order for constructing a plurality of publishable objects based on at least one inclusion relationship between an object and the at least one fragment; and
constructing the plurality of publishable objects based on the at least one inclusion relationship and the determined order for constructing the objects.

9. The program storage device as recited in claim 8, further comprising the step of determining the at least one inclusion relationship between the at least one fragment and the object.

10. The program storage device as recited in claim 8, further comprising the step of verifying one of an existence and a currency of a first object referenced by a second object.

11. The program storage device as recited in claim 10, further comprising the step of delaying publication of the second object in response to the first object being one of non-existent and obsolete.

12. The program storage device as recited in claim 8, further comprising the steps of:
examining a plurality of constructed objects; and
rejecting at least one constructed object based on content; and
approving publication of at least one of remaining constructed objects.

13. The program storage device as recited in claim 8, wherein the objects include Web pages and further comprising the step of detecting broken hypertext links between Web pages.

14. The program storage device as recited in claim 8, further comprising the steps of:
detecting changes to the objects; and
automatically updating the objects according to the order.

15. A system for constructing a plurality of objects comprising:
a content authoring system adapted for generating fragments and providing include relationships between the fragments, wherein a fragment is an object that is a component of an object which is constructed using the fragment;
a dependency parser adapted for receiving the fragments and parsing the include relationships;
a dependency analyzer adapted for determining an order for constructing the plurality of objects from the fragments based on the include relationships; and
a constructor adapted for constructing the plurality of objects in the order determined by the dependency analyzer.

16. The system as recited in claim 15, wherein the dependency analyzer employs object dependence graphs to determine an order for constructing the objects.

17. The system as recited in claim 15, wherein the content authoring system includes fragments input from at least one of humans, machines and combinations of humans and machines.

18. The system as recited in claim 15, further comprising a consistency checker for preventing publication of inconsistent objects.

19. The system as recited in claim 18, wherein the system constructs Web pages and the consistency checker further includes a component for determining broken hypertext links between the Web pages.

20. The system as recited in claim 15, wherein the constructor includes a page constructor for constructing Web pages from the plurality of objects.

21. A computer-executable method for constructing objects comprising the steps of:
providing a plurality of fragments, wherein a fragment is an object that is a component of an object which is constructed using the fragment;
determining an order for constructing a plurality of objects based on at least one inclusion relationship between the plurality of fragments; and
constructing the plurality of objects using one or more of said plurality of fragments based on the at least one inclusion relationship and the determined order for constructing the plurality of objects.

22. A program storage device readable by machine, tangibly embodying a program of instructions executable by the machine to perform method steps for constructing objects, the method steps comprising:
providing a plurality of fragments, wherein a fragment is an object that is a component of an object which is constructed using the fragment;
determining an order for constructing a plurality of objects based on at least one inclusion relationship between the plurality of fragments; and
constructing the plurality of objects using one or more of said plurality of fragments based on the at least one inclusion relationship and the determined order for constructing the plurality of objects.
